(19) United States
(12) Patent Application Publication
(10) Pub. No.: US 2005/0073972 A1
(43) Pub. Date: Apr. 7, 2005

(54) Half-duplex radio communication apparatus, half-duplex radio communication system, and half-duplex radio communication method

(76) Inventor: Naoki Hasegawa, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/950,661

(22) Filed: Sep. 28, 2004

(30) Foreign Application Priority Data
Oct. 3, 2003 (JP) 345646/2003

(51) Int. Cl. H04B 7/00

(52) U.S. Cl. 370/328; 370/296

(57) ABSTRACT

With the press-to-talk switch pushed down to start transmission of voice information, a user can additionally push down a shutter button to start shooting by a camera. The obtained image data can be transmitted as in the transmission of the voice information to other radio communication terminals in a Talk group within the range of transmission rate of an allocated line in a radio communication system. It is thereby possible to enable transmission of the image data by a simple operation through a general radio communication line within the range of transmission rate of the allocated line without any stress even in transmission of higher resolution frozen-frame viewing.

### BACKGROUND OF THE INVENTION

1. Field of the Invention

The present invention relates to a half-duplex radio communication apparatus, a half-duplex radio communication system, and a half-duplex radio communication method which enable radio communication in a half-duplex transmission mode.

2. Description of the Related Art

In the prior art, for example, a transceiver is known as a half-duplex radio communication apparatus which enables radio communication in a half-duplex transmission mode.

In such a half-duplex radio communication apparatus, while a user pushes down a press-to-talk switch, the terminal can transmit user's voice obtained via a microphone, but can receive no voice (transmitting condition). In turn, while releasing the press-to-talk switch, the terminal can receive other voices, but can transmit the user's voice (receiving condition).

In such a half-duplex radio communication, these apparatuses are generally limited only to voice communication, but additional purposes have been suggested. For example, Japanese Patent Laid-open No. Hei11-46354(cited document 1) discloses a voice/image simultaneous transmission apparatus which multiplexes a voice signal and an image signal for transmission in the half-duplex transmission mode. In the apparatus, a sending end divides into blocks having a predetermined size image signals sequentially read out from an image memory, resulting in sequential multiplexing of the image blocks and the voice signals. When a press-to-talk switch is closed, the sending end starts transmission. When the press-to-talk switch is opened, the transmission is stopped at the instant of termination of transmission of an image block immediately after the switch opening.

On the other hand, Japanese Patent Publication (Kohyo) No. 2002-517965 (cited reference 2) discloses dynamic allocation of a radio source in a packet switched communication system. In the system, a data packet handler holds control data used for displaying a condition of a telephone between a first user station and a second user station. Radio sources are dynamically allocated for transfer of a data packet used for transmission of call data for the telephone on a radio interface such that an amount of allocated radio sources is varied according to an amount of transferred call data at various points in the telephone.

However, the above two prior-arts have respectively drawbacks. According to the art disclosed in the cited document 1, it is possible to simultaneously transmit the image data and the voice data. The cited reference 1's technique is suitable for visual telephone use for low amount data. That is, it is possible to transmit at any time data of low resolution image requiring a-smaller amount of data in a simple operation. However, there is a drawback in that, as higher resolution image should be shot, voice communication may more frequently be interrupted due to impossibility of real time communication.

Further, the image and the voice are simultaneously transmitted so that a user cannot accurately grasp timing of the interruption in the voice communication. Thus, there is another drawback in that accidental interruption may put the user under stress during the transmission.

In recent years, higher resolution has been observed in still image viewing to be taken by a camera embedded in a radio communication terminal such as portionable telephone. Consequently, it can be concluded that new type of half-duplex radio communication apparatus will more generally be demanded to transmit higher resolution still image or frame viewing by a simple operation without any stress.

On the other hand, the cited reference 2 shows the art in which a bandwidth (radio source) is dynamically varied according to the amount of transferred call data. The technique is suitable for half-duplex communication in video conferencing because the bandwidth can dynamically be controlled even when transmitting video data requiring a relatively wide bandwidth only in one direction at a time. However, the technique cannot be applied to a general radio communication line since a wider bandwidth cannot be allocated to a specific user.

In other words, no consideration is given to a demand that a user transmits image data without any trouble through the general radio communication line within the range of transmission rate of the allocated line.

### SUMMARY OF THE INVENTION

In view of the foregoing problems, it is an object of the present invention to provide a half-duplex radio communication apparatus, a half-duplex radio communication system, and a half-duplex radio communication method which enable transmission of image data by a simple operation through a general radio communication line within the range of transmission rate of an allocated line without any stress even in transmission of higher resolution frozen-frame viewing.

According to the first aspect of the present invention, for achieving the above-mentioned object, there is provided a half-duplex radio communication apparatus including radio communication portion, image pickup portion, a press-to-talk switch, and an image pickup switch, and enabling radio communication in a half-duplex transmission mode. Further, the half-duplex radio communication apparatus includes controller for making a control to, when pushing down the image pickup switch with the press-to-talk switch held down, set the radio communication portion to transmit image data obtained by the image pickup portion to a call party.

Preferably, display for displaying various kinds of information is provided such that, when receiving the image data from the call party, the received image is displayed on the display.

Preferably, the display displays, while the image data obtained by the image pickup portion is being transmitted to the call party, a message stating that the image data is being transmitted for posting to this effect.

Preferably, the image data obtained by the image pickup portion is transmitted within the range of transmission rate of an allocated line.

Further, according to the second aspect of the present invention, there is provided a half-duplex radio communication system including a plurality of half-duplex radio communication apparatus, a radio base station, and radio communication system control portion. In the half-duplex radio communication system, the radio base station is connected to the radio communication system controller, and communication is enabled between the half-duplex radio communication apparatus through the radio base station. In the half-duplex radio communication system, the half-duplex radio communication apparatus includes radio communication portion, image pickup portion, a press-to-talk switch, and an image pickup switch, and enables radio communication in a half-duplex transmission mode. Further, the half-duplex radio communication apparatus includes controller for making a control to, when pushing down the image pickup switch with the press-to-talk switch held down, set the radio communication portion to transmit image data obtained by the image pickup portion to a call party.

Preferably, the half-duplex radio communication apparatus includes display for displaying various kinds of information such that, when receiving the image data from the call party, the received image is displayed on the display.

Preferably, the display displays, while the image data obtained by the image pickup portion is being transmitted to the call party, a message stating that the image data is being transmitted for posting to this effect.

Preferably, the call party is all other half-duplex radio communication apparatus belonging to a Talk group previously recorded in the radio communication system controller.

Preferably, the image data obtained by the image pickup portion is transmitted within the range of transmission rate of an allocated line in the half-duplex radio communication system.

Further, according to the third aspect of the present invention, there is provided a half-duplex radio communication method used between half-duplex radio communication apparatus including radio communication portion, image pickup portion, a press-to-talk switch, and an image pickup switch, and enabling radio communication in a half-duplex transmission mode. The half-duplex radio communication method includes the steps of setting, when pushing down the image pickup switch with the press-to-talk switch held down, the image pickup portion to obtain an image, and setting the radio communication portion to transmit obtained image data to a call party.

Preferably, the half-duplex radio communication apparatus displays, when receiving the image data from the call party, the received image on the display.

Preferably, the display displays, while the image data obtained by the image pickup portion is being transmitted to the call party, a message stating that the image data is being transmitted for posting to this effect.

Preferably, the image data obtained by the image pickup portion is transmitted within the range of transmission rate of an allocated line.

As set forth above, according to the present invention, it is possible to transmit the image data by the simple operation without putting the user under any stress even in transmission of higher resolution frozen-frame viewing.

### BRIEF DESCRIPTION OF THE DRAWINGS

FIG. 1 is a diagram roughly showing a configuration of a radio communication system according to an embodiment of the present invention;

FIG. 2 is a block diagram roughly showing a configuration of a radio communication terminal in the radio communication system;

FIG. 3 is a block diagram roughly showing a configuration of a radio base station in the radio communication system;

FIG. 4 is a block diagram roughly showing a configuration including a PTT server 3 and a CUG server 4 in the radio communication system;

FIG. 5 is a sequence chart roughly showing processing steps required for radio communication between a plurality of radio communication terminals belonging to a Talk group;

FIG. 6 is a sequence chart roughly showing operation steps required to transmit image data obtained by a camera 19 to another radio communication terminal 1 in the Talk group;

FIG. 7 is a diagram showing an illustrative display in a camera mode; and

FIG. 8 is a diagram showing an illustrative message stating that the image data is being transmitted.

### DESCRIPTION OF THE PREFERRED EMBODIMENTS

A detailed description will now be given of preferred embodiments of a half-duplex radio communication apparatus, a half-duplex radio communication system, and a half-duplex radio communication method according the invention referring to the accompanying drawings.

The embodiment shows a preferable illustration in which image data can easily be transmitted by a simple control in a half-duplex transmission mode.

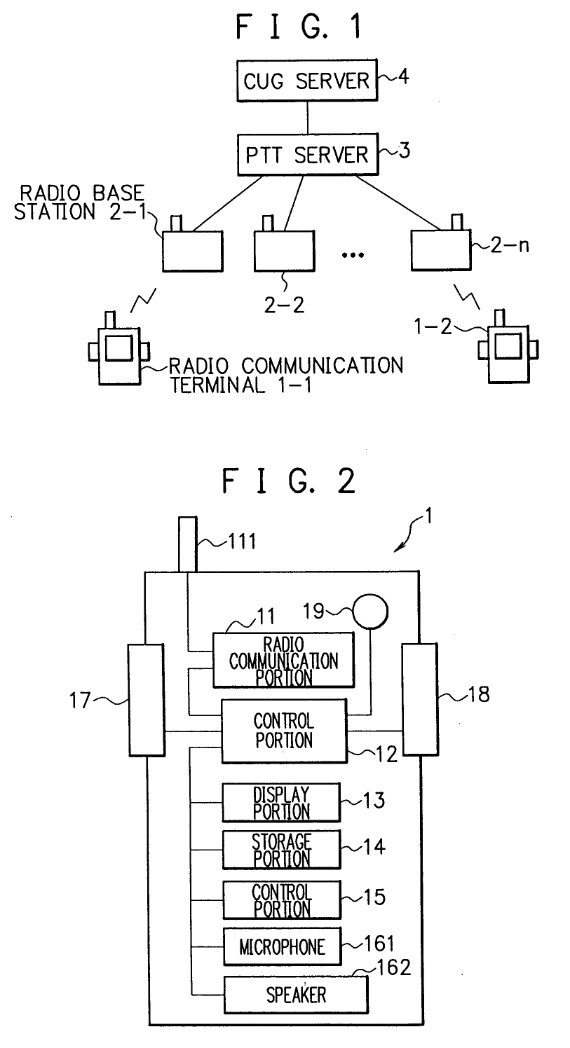

In the embodiment, as shown in FIG. 1, the radio communication system (half-duplex radio communication system) includes radio communication terminals (half-duplex radio communication apparatus) 1 (1-1, 1-2, . . . ), radio base stations 2 (2-1, 2-2, . . . ) for radio communication with the radio communication terminal 1, a PTT (Push To Talk) server 3, and a CUG (Closed User Group) server 4. Further, the PTT server 3 is connected to the radio base stations 2, and the CUG server 4.

Such a configuration permits radio communication between each one of the radio communication terminals 1 and the radio base stations 2 within the range in which radio communication is enabled, thereby establishing the radio communication between the radio communication terminal 1 and the other radio communication terminal 1. In addition, the configuration ensures continuous communication. That is, disconnection of the radio communication can be avoided even if, while a phone call is engaged, the radio communication terminal 1 moves from one service area (the range in which the radio communication is enabled) of the radio base station 2 to another service area of the other radio base station 2.

As shown in FIG. 2, the radio communication terminal 1 includes a radio communication portion 11, a control portion 12, a display portion 13, a storage portion 14, a control portion 15, a microphone (transmitting portion) 161, a speaker (receiving portion) 162, a press-to-talk switch 17, a shutter button (image pickup switch) 18, a camera (image pickup portion) 19, and an antenna 111 connected to the radio communication portion 11.

The radio communication portion 11 carries out signal processing required for the radio communication via the antenna 111 to make a control of the radio communication.

The control portion 12 makes an entire control of the radio communication terminal 1.

The display portion 13 displays and posts to a user various kinds of information required to establish the radio communication.

The storage portion 14 contains various kinds of information such as information used to pinpoint the other radio communication terminal 1 in a set Talk group, or an address of the CUG server 4.

The control portion 15 is provided for all kinds of inputs required for the user to control the radio communication terminal 1, for example, to make a switch of a display mode in the display portion 13.

The radio communication terminal 1 carries out the radio communication in a half-duplex transmission mode. Thus, when the user controls the radio communication terminal 1 to transmit voice to the other radio communication terminal 1 (call party) in a preset Talk group, the user may push down the press-to-talk switch 17 to select a transmitting condition. In this condition, the voice is received via the microphone 161, and is transmitted to the other radio communication terminal 1 in the Talk group.

The Talk group is previously recorded in the CUG server 4 in some way such as a recording method using a network.

In a receiving condition, the press-to-talk switch 17 is not held down. Therefore, when the other radio communication terminal 1 in the Talk group transmits a voice, the radio communication terminal 1 can receive the voice to produce a speech via the speaker 162.

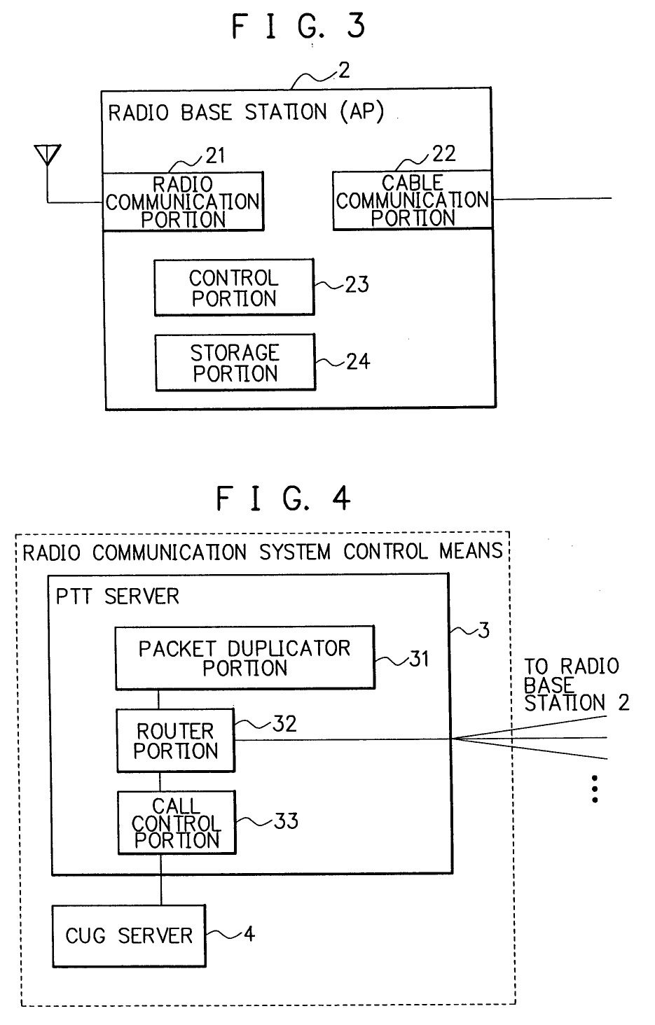

As shown in FIG. 3, the radio base station 2 includes a radio communication portion 21, a cable communication portion 22, a control portion 23 to make a control of all the apparatus in the base station, and a storage portion 24.

In response to a connection request from the radio communication terminal 1, the radio communication portion 21 starts radio communication with the radio communication terminal 1, and the cable communication portion 22 communicates with the PTT server 3 connected thereto. This allows transmission/receive of data such as voice information between the radio communication terminal 1 and the call party, i.e., the other radio communication terminal 1 in the Talk group.

The storage portion 24 contains, for example, information of the radio communication terminal 1 associated with the radio base station 2.

As shown in FIG. 4, the PTT server 3 includes a packet duplicator portion 31, a router portion 32, and call control portion 33.

In response to communications with the respective radio base stations 2 connected to the router portion 32, the call control portion 33 makes a connection control depending upon an authentication result obtained from the CUG server 4. In order to transmit data transmitted from the one radio communication terminal 1 to all other terminals in the Talk group, the packet duplicator portion 31 duplicates a packet of the transmitted data by the predetermined number. The router portion 32 transmits the duplicated packets to the radio base stations 2 associated with the radio communication terminal 1 serving as a destination end.

When receiving the connection request from the radio communication terminal 1, the CUG server 4 authenticates the request to determine whether connection is enabled or disabled. Further, since the CUG server 4 contains the previously recorded information of the Talk group as described above, the CUG server 4 can transmit, after the connection authentication, to the PTT server 3 the information of the Talk group to which the radio communication terminal 1 requesting the connection belongs.

Thus, the above PTT server 3 and CUG server 4 make the control of the communication from the radio communication terminal 1 through the radio base station 2, thereby serving as radio communication system controller in the radio communication system according to the embodiment.

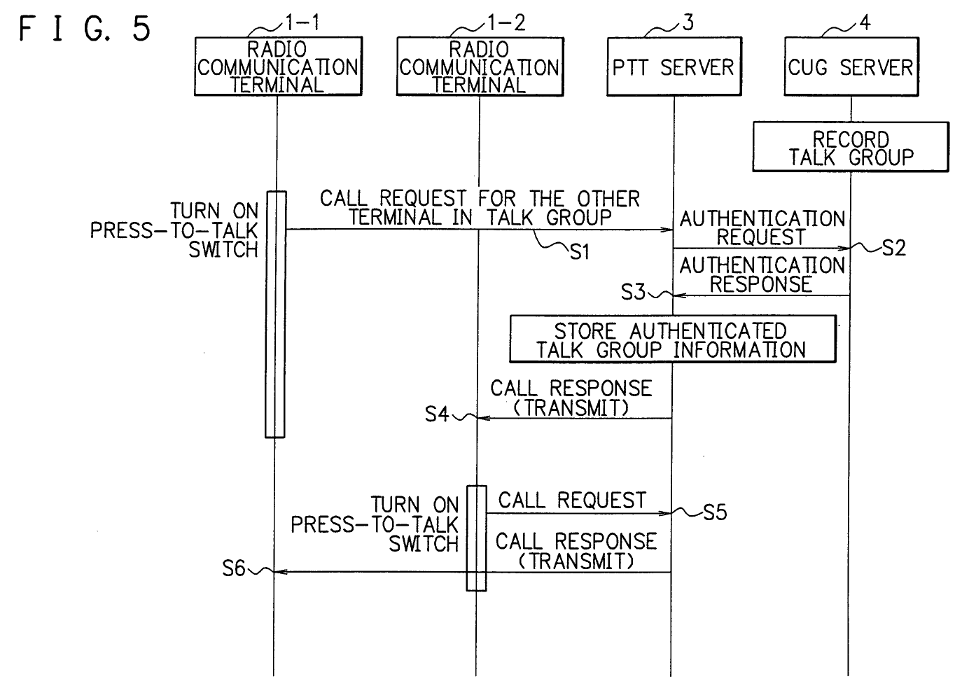

A description will now be given of processing steps required for the radio communication between the plurality of radio communication terminals 1 belonging to the Talk group referring to FIG. 5. In the following illustrative discussion, the radio communication terminals 1 belonging to the Talk group are the radio communication terminal 1-1 and the radio communication terminal 1-2.

First, when the user pushes down (turns ON) the press-to-talk switch 17 of the radio communication terminal 1-1, the radio communication terminal 1-1 transmits to the PTT server 3 a call request for the other radio communication terminal 1 in the Talk group (Step S1).

In response to the call request, the call control portion 33 of the PTT server 3 checks whether or not an unillusrated storage portion contains authentication result information (information obtained by the authentication, showing that the connection is enabled) related to the Talk group to which the radio communication terminal 1-1 belongs.

If the authentication result information is not found, the call control portion 33 transmits an authentication request to the CUG server 4 (Step S2). Then, the CUG server 4 carries out authentication depending upon previously recorded information of the Talk group, and transmits an authentication response (Step S3).

When as the authentication response are transmitted connection permission and the information of the Talk group to which the radio communication terminal 1-1 belongs, the PTT server 3 stores the authenticated Talk group information in the unillustrated storage portion. Further, the PTT server 3 transmits information such as voice transmitted from the radio communication terminal 1-1 to the other radio communication terminal 1 in the Talk group, i.e., to the radio communication terminal 1-2 (Step S4).

When transmission from the radio communication terminal 1-1 is ended, a press-to-talk switch 17 is released (turned OFF). Thereafter, with the PTT server 3 containing the authenticated Talk group information obtained in the above-described manner, pushed down is a press-to-talk switch 17 of the radio communication terminal 1-2 belonging to the Talk group (Step S5). In response to the call request from the radio communication terminal 1-2, the PTT server 3 transmits, depending upon Talk group information stored therein, information transmitted from the radio communication terminal 1-2 to the other radio communication terminal 1 in the Talk group, i.e., to the radio communication terminal 1-1 (Step S6).

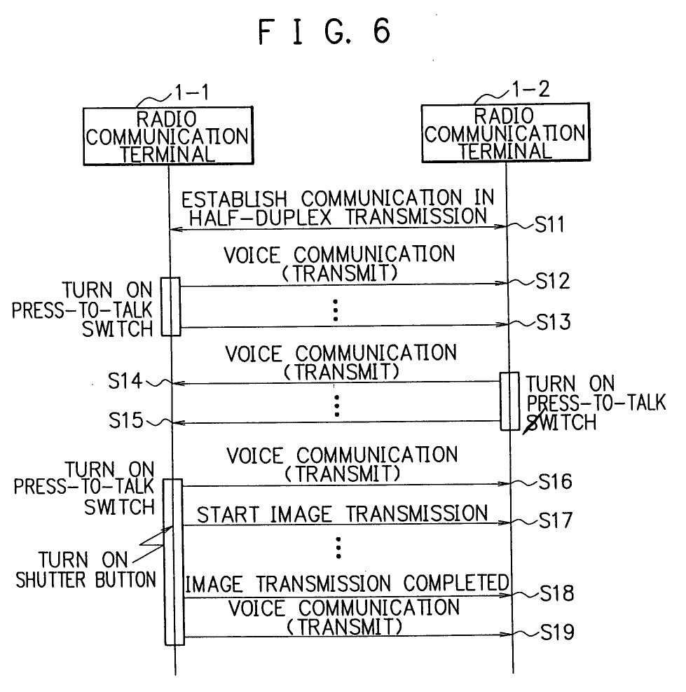

A description will now be given of operation steps required to transmit image data obtained by the camera 19 to the other radio communication terminal 1 in the Talk group referring to FIG. 6.

As stated above, communication can be established in the half-duplex transmission mode between the radio communication terminal 1-1 and the radio communication terminal 1-2 (Step S11). Thus, the user only has to push down the press-to-talk switch 17 to transmit, to the other radio communication terminal 1 in the Talk group, voice information obtained from the radio communication terminal 1 of which the press-to-talk switch 17 is held down (Steps S12 to S15).

Further, with the press-to-talk switch 17 pushed down to start the transmission of the voice information (Step S16), the user may additionally push down (turn ON) the shutter button 18. This starts shooting by the camera 19, and the obtained image data can be transmitted to the other radio communication terminal 1 in the Talk group within the range of transmission rate of an allocated line in the radio communication system as in the transmission of the voice information (Steps S17 to S18).

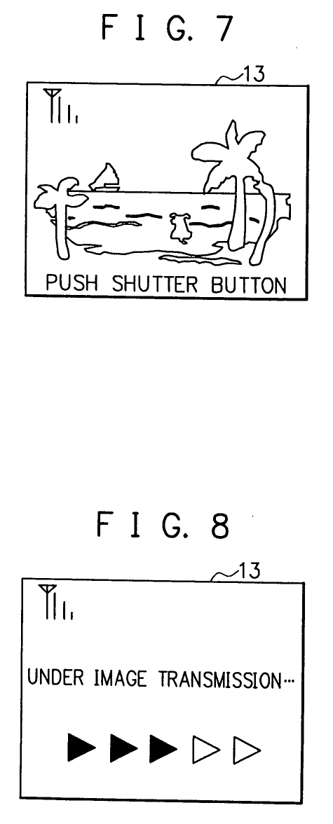

For the photo shooting, the user may select a camera mode of the radio communication terminal 1-1, in which a photo can be taken by the camera 19. Then, as illustratively shown in FIG. 7, the display portion 13 shows an image to be taken by the camera 19. The user can push down the shutter button 18 while checking the image to be taken via the display portion 13, resulting in reliable shooting.

In addition, even when the user checks the image to be taken, the user can simultaneously transmit voice as long as the press-to-talk switch 17 is held down. For example, the user may send a voice message, to the other radio communication terminal 1 in the Talk group, stating that the image shown on the display portion 13 will now be transmitted, and may push down the shutter button 18 to transmit the displayed image.

At the same time that the shutter button 18 is pushed down to start transmission of the obtained image data, the display portion 13 displays a message posting, as illustratively shown in FIG. 8, that the image data is being transmitted. The message is kept displayed for a time interval between a start and a termination of the transmission (i.e., kept displayed while the image data is being transmitted).

This allows the user to ensure that the user's radio communication terminal 1 is in the process of the transmission of image data. Thus, even if transmitting user's voice simultaneously, the user can recognize a degraded communication condition in which the voice may be interrupted. It is possible for the user to carry out the transmission of image data without putting the user under stress due to inadvertent interruption of the transmission of voice data.

After the transmission of image data is ended, voice transmission can be continued as long as the press-to-talk switch 17 is held down (Step S19).

This permits the user who has been transmitted the image data, to send an additional message to a user of the other radio communication terminal 1 in the Talk group. For example, the transmitting user may send a voice message stating that the transmission of image data has been ended, and may inquire as to whether or not the receiving user can clearly see the transmitted image.

As set forth above, according to the embodiment, only by pushing down the shutter button 18 in the transmitting condition in which the press-to-talk switch 17 is held down, the user at the transmitting end can transmit the image obtained by the camera 19 to all other radio communication terminals 1 (call party) in the Talk group.

On the other hand, only by waiting in the receiving condition in which the transmitted voice can be received without any additional operation, the receiving end user can see the transmitted image data displayed on the display portion 13 of the radio communication terminal 1 of the receiving end user.

Further, only by pushing down the shutter button 18 at the radio communication terminal 1 in the half-duplex transmission mode, it is possible to transmit the image to the destination terminal, and display the image thereon. It is thereby possible to eliminate a time-consuming process required for receiving, for example, image data attached to e-mail, in which the receiving end user has to open the transmitted mail data. In addition, the transmitting end user may only have to perform a simple operation, that is, push down the shutter button 18 while pushing down the press-to-talk switch 17. The simple operation enables the receiving end user to see the transmitted image.

Further, as stated above, during the transmission of image data, the display portion 13 displays the message stating that the image data is being transmitted. For example, when transmitting a higher resolution frozen-frame viewing, the transmission rate of the radio communication line becomes inevitably lower in comparison with the amount of data in the obtained image data. Even in such a case, the user may only have to perform the simple operation in the condition in which the voice communication is continued. It is thereby possible to transmit the image data without putting the user under stress due to inadvertent interruption of the transmission of voice data.

While the above embodiment has been described as a preferred embodiment of the invention, and it is to be understood that changes and variations may be made without departing from the spirit or scope of the following claims.

For example, in the embodiment, for the photo shooting by the camera 19, the user selects the camera mode of the radio communication terminal 1. However, the user may preset the mode, or may perform the switching between the modes after pushing down the press-to-talk switch 17.

Further, the camera 19 may be provided with a member for protecting a lens. In addition, when the protecting member is opened to the lens (the camera 19 is ready for photo shooting), the radio communication terminal 1 may automatically be switched over to the camera mode in conjunction with movement of the member.

Alternatively, instead of the switching of modes, the image to be taken by the camera 19 may normally be displayed on the display portion 13.

Further, other than the radio communication terminal 1, the present invention may be applied to any type of apparatus enabling the radio communication in the half-duplex transmission mode, and having the camera such as a portionable telephone, or a PDA (Personal Digital Assistant).

1. A half-duplex radio communication apparatus comprising
a radio communication part, image pickup part, a press-to-talk switch, an image pickup switch, enabling radio communication in a half-duplex transmission mode, and
a controller for controlling to, when pushing down the image pickup switch with the press-to-talk switch held down, set the radio communication portion to transmit image data obtained by the image pickup portion to a call party.

2. A half-duplex radio communication apparatus according to claim 1, further comprising display for displaying various kinds of information,
wherein, when receiving the image data from the call party, the received image is displayed on the display.

3. A half-duplex radio communication apparatus according to claim 1, wherein the display displays, while the image data obtained by the image pickup portion is being transmitted to the call party, a message stating that the image data is being transmitted for posting to this effect.

4. A half-duplex radio communication apparatus according to claim 2, wherein the display displays, while the image data obtained by the image pickup part is being transmitted to the call party, a message stating that the image data is being transmitted for posting to this effect.

5. A half-duplex radio communication apparatus according to any one of claim 1, wherein the image data obtained by the image pickup portion is transmitted within the range of transmission rate of an allocated line.

6. A half-duplex radio communication apparatus according to any one of claim 2, wherein the image data obtained by the image pickup portion is transmitted within the range of transmission rate of an allocated line.

7. A half-duplex radio communication apparatus according to any one of claim 3, wherein the image data obtained by the image pickup portion is transmitted within the range of transmission rate of an allocated line.

8. A half-duplex radio communication system comprising:
a plurality of half-duplex radio communication apparatus, a radio base station, and radio communication system controller,
the half-duplex radio communication system in which the radio base station is connected to the radio communication system controller, and communication is enabled between the half-duplex radio communication apparatus through the radio base station,
wherein the half-duplex radio communication apparatus includes radio communication part, image pickup part, a press-to-talk switch, an image pickup switch, and enables radio communication in a half-duplex transmission mode, and
controller for making a control to, when pushing down the image pickup switch with the press-to-talk switch held down, set the radio communication part to transmit image data obtained by the image pickup part to a call party.

9. A half-duplex radio communication system according to claim 8, wherein the half-duplex radio communication apparatus further comprises display for displaying various kinds of information, and
when receiving the image data from the call party, the received image is displayed on the display.

10. A half-duplex radio communication system according to claim 8, wherein the display displays, while the image data obtained by the image pickup part is being transmitted to the call party, a message stating that the image data is being transmitted for posting to this effect.

11. A half-duplex radio communication system according to claim 8, wherein the call party is all other half-duplex radio communication apparatus belonging to a Talk group previously recorded in the radio communication system controller.

12. A half-duplex radio communication system according to claim 8, wherein the image data obtained by the image pickup part is transmitted within the range of transmission rate of an allocated line in the half-duplex radio communication system.

13. A half-duplex radio communication system according to claim 9, wherein the image data obtained by the image pickup part is transmitted within the range of transmission rate of an allocated line in the half-duplex radio communication system.

14. A half-duplex radio communication system according to claim 10, wherein the image data obtained by the image pickup part is transmitted within the range of transmission rate of an allocated line in the half-duplex radio communication system.

15. A half-duplex radio communication system according to claim 11, wherein the image data obtained by the image pickup part is transmitted within the range of transmission rate of an allocated line in the half-duplex radio communication system.

16. A half-duplex radio communication method used between half-duplex radio communication apparatus including radio communication part, image pickup part, a press-to-talk switch, an image pickup switch, and enabling radio communication in a half-duplex transmission mode, the half-duplex radio communication method comprising the steps of:
setting, when pushing down the image pickup switch with the press-to-talk switch held down, the image pickup portion to obtain an image, and setting the radio communication portion to transmit obtained image data to a call party.

17. A half-duplex radio communication method according to claim 16, wherein the half-duplex radio communication apparatus displays, when receiving the image data from the call party, the received image on the display.

18. A half-duplex radio communication method according to claim 16, wherein the display displays, while the image data obtained by the image pickup part is being transmitted to the call party, a message stating that the image data is being transmitted for posting to this effect.

19. A half-duplex radio communication method according to claim 16, wherein the image data obtained by the image pickup part is transmitted within the range of transmission rate of an allocated line.
